(19) United States
(12) Patent Application Publication
(10) Pub. No.: US 2007/0141934 A1
(43) Pub. Date: Jun. 21, 2007

(54) Nonwoven webs containing bacteriostatic compositions and methods of making the same

(75) Inventors: Curtis N. Sayre, Atlanta, GA (US); Shawn R. Feaster, Duluth, GA (US); Julie Villanueva, Decatur, GA (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/303,010

(22) Filed: Dec. 15, 2005

(51) Int. Cl. B32B 27/04; B32B 5/02

(52) U.S. Cl. 442/123; 442/413; 442/400

(57) ABSTRACT

Nonwoven webs, such as coform webs, treated with a bacteriostatic composition are generally disclosed. The treated webs can attract and/or trap negatively charged matter, such as bacteria and other pathogens. The bacteriostatic composition can comprise a cationic polymer, a cationic oligomer, or particles coated with a cationic material. The bacteriostatic composition can be bonded to the fibers of the nonwoven web in a manner such that the bacteriostatic composition is not substantially transferable to the web's surrounding environment.

### BACKGROUND OF THE INVENTION

A myriad of different types of fibrous webs are commercially available in today's marketplace. These fibrous webs can contain chemicals designed with a particular use in mind. For example, fibrous webs can contain chemicals designed to kill pathogens, such as bacteria, when the web comes into contact with them.

However, as concern grows about exposure to, allergic reactions created by, and/or sensitivity to chemicals and about the increasing resistance of bacteria to common drug treatments, it has become more desirous to avoid exposure harsh chemicals while still providing a bacteria removing web.

Many pathogens are generally electro-statically charged. For example, most bacteria have a net negative charge associated with their membrane. As such, pathogens, such as bacteria, are susceptible to electrostatic attraction to oppositely charged molecules. For instance, negatively charged bacteria can be attracted to a strong positive charge, such as a cation. While this attraction may not kill the attracted bacteria, it can help remove the bacteria from its environment.

As such, a need currently exists for a fibrous web that can provide a decontamination effect without the undesirable effects of harsh antimicrobial chemicals. A need also exists for a web that can have a decontaminatation effect through the use of electrostatic forces.

### SUMMARY OF THE INVENTION

In general, the present disclosure is directed to a substrate comprising a nonwoven web. For instance, the nonwoven web can contain natural fibers such as wool, cotton, flax, hemp, wood pulp, or combinations thereof. The nonwoven webs can be treated with a bacteriostatic composition that is capable of attracting and/or trapping pathogens, such as bacteria. The present inventors have discovered that by treating a nonwoven web material with a bacteriostatic composition, the hydrophobicity of the material is greatly increased.

In particular, nonwoven webs made according to the present disclosure display increased contact angles to liquids, such as water and blood. For instance, once the nonwoven web is treated with the bacteriostatic composition, the contact angle of the material against various liquids may increase by at least about 10% when compared to the contact angle of the untreated web. For example, in some embodiments, the treated web can have a contact angle increased by at least about 20%, such as increase by at least about 30%. For instance, the contact angle of a treated nonwoven web made in accordance with the present disclosure against water may be greater than about 110°, such as greater than about 115°, such as greater than about 120°. When tested against blood, the contact angle of the treated nonwoven web may be greater than about 115°, such as greater than about 118°, such as greater than about 120°.

For example, in one embodiment, the nonwoven web can be a coform web. A coform webs can contain a combination of polymeric fibers and natural fibers, such as cellulosic fibers. The present inventors have discovered that by treating a coform material with a bacteriostatic composition, the hydrophobicity of the coform material can be greatly increased.

Thus, these materials have been found to be very efficient barriers to blood and other biological liquids. Consequently, such materials can be used as wound or surgical dressings, hospital gowns, surgical drapes, and other medical garments.

Other features and aspects of the present invention are discussed in greater detail below.

### BRIEF DESCRIPTION OF THE FIGURES

A full and enabling disclosure of the present invention, including the best mode thereof to one skilled in the art, is set forth more particularly in the remainder of the specification, which includes reference to the accompanying figures, in which:

FIG. 1 is an exemplary embodiment of a process and apparatus for producing a coform web of the present invention;

FIGS. 2A and 2B are exemplary meltblown die heads for use in the process and apparatus of FIG. 1; and

FIG. 3 depicts a contact angle of a liquid on a surface.

Repeat use of reference characters in the present specification and drawings is intended to represent the same or analogous features or elements of the present invention.

### DETAILED DESCRIPTION

it is to be understood by one of ordinary skill in the art that the present discussion is a description of exemplary embodiments only, and is not intended as limiting the broader aspects of the present invention.

In general, the present disclosure is directed toward a fibrous web, such as a coform web, containing a bacteriostatic composition. The bacteriostatic composition can attract and/or trap pathogens, such as bacteria, into the web. As such, the bacteriostatic composition allows the web to help prevent transfer of bacteria through the web. Also, the bacteriostatic composition can substantially hold the pathogens in the web to help prevent the spread of the pathogens to other surfaces that may contact the web.

According to the present disclosure, the bacteriostatic composition can attract and trap negatively charged matter, such as bacteria, allergens, anionic molecules, and the like, through the application of physical means and Coulombic attraction, without the use of harsh chemicals such as some antimicrobials. For example, the bacteriostatic composition can provide a positive charge to the web that can electrostatically attract and/or trap negatively charged matter, such as molecules, particles, microbes, cells, fungi, anions, other microorganisms, pathogens, and the like. Also, the bacteriostatic composition can hinder the reproduction and growth of bacteria that is trapped within the web.

Of particular advantage, the bacteriostatic composition can help protect against the spread or infection of pathogens without the use of chemicals, such as antiseptics or antibiotics. When applied to a web, for instance, the bacteriostatic composition provides a localized system for removing negatively charged particles or microorganisms without damaging any surface or object that is contacted by the web.

The bacteriostatic composition can also interact, such as chemically, electrostatically, or physically, with the fibers of the web. As such, the bacteriostatic composition can become integral to the fibers of the web and can become embedded into the web.

In one embodiment, the bacteriostatic composition contains a chemical compound having a net positive charge. The chemical compound, for instance, may comprise a cationic polymer, a cationic oligomer, or mixtures thereof. In one embodiment, the bacteriostatic composition may contain nanoparticles treated with a cationic compound or polymer. The particular components contained in the bacteriostatic composition may depend upon the particular application and the desired result.

Chemical compounds that may be incorporated into the bacteriostatic composition may include, for instance, cationic polymers, cationic oligomers, mixtures thereof, and particles that are coated with the above cationic materials. In general, any suitable positively charged material may be incorporated into the bacteriostatic composition that is capable of being bonded to or incorporporated into a fibrous web.

In one particular embodiment, for instance, a cationic oligomer may be incorporated into the bacteriostatic composition. The cationic oligomer may comprise an organic or inorganic oligomer. For instance, examples of inorganic oligomers include aluminum oligomers. Aluminum oligomers may include, for instance, aluminum chlorohydrol, aluminum chlorohydrate, and oligomers formed from the same. Aluminum chlorohydrate can be represented as follows: Al₂(OH)₆₋ₙClₙ, wherein n can be from 1 to 5. Without wishing to be bound by theory, it is believed that aluminum chlorohydrate forms an aluminum oligomer in an aqueous solution. The size of the oligomer may be dependent on the concentration of the aluminum chlorohydrate aqueous solution.

In addition to the above, any suitable metal ion, complex, or metal containing molecule possessing sufficient positive charge may be used and incorporated into the bacteriostatic composition. Further, in addition to aluminum oligomers, various other positively charged aluminum compounds may be used. For instance, any suitable aluminum salt may be present in the bacteriostatic composition.

Cationic polymers that may be used in the bacteriostatic composition include, for instance, polyethyleneimine, high charged density polyelectrolites such as poly(methacryloxyethyl) trimethylammonium bromide poly(acrylic) acid and epichlorohydrin-functionalized polyamines. Such polymers are commercially available from Hercules Inc., of Wilmington, Del. under the tradenames KYMENE®, and RETEN®, from National Starch and Chemical Company of Bridgewater, N.J. under the tradename COBOND® and from Calgon Polymers of Pittsburgh, Pa.

In still another embodiment, the bacteriostatic composition may contain cationic particles or particles coated with a cationic material. For instance, the bacteriostatic composition may contain nanoparticles coated with an aluminum oligomer. The nanoparticles may comprise, for instance, silica particles or alumina particles. Nanoparticles coated with aluminum chlorohydrate, for example, are available from Nissan Chemicals, Inc. of Houston, Tex. under the tradename SNOWTEX®.

In addition to coated particles, positively charged aluminum particles or alumina particles may be used. The particles may be made exclusively from the above materials or may contain a binder if desired.

In addition to the above materials, it should be understood that any other suitable cationic material that is capable of bonding or being bonded to a nonwoven web may be used in the bacteriostatic composition of the present disclosure. Desirably, the positively charged materials are mild on the skin, are not appreciably antimicrobial in nature, and do not leach substantially once bonded to the surface of a substrate.

The webs of the present disclosure can be treated with the bacteriostatic composition according to any method. For example, the web can be saturated with a solution containing the bacteriostatic composition. After saturation, the web can be dried, allowing the bacteriostatic composition to remain integral to the fibers of the web. The bacteriostatic composition can bond to the fibers of the web. For example, the bacteriostatic composition can ionically bond or covalently bond to the fibers. As such, the bacteriostatic composition can remain integral to the web and is not transferred to the web's surrounding environment.

Alternatively, or in addition to, the bacteriostatic composition can be sprayed or printed on the nonwoven web by any method. In yet another embodiment, the bacteriostatic composition can be added to the pulp prior to forming the nonwoven web.

Any fibrous web can be treated with the bacteriostatic composition of the present disclosure. For instance, in one particular embodiment, a fibrous web containing natural fibers can be treated with the bacteriostatic composition. For example, the natural fibers can be cellulosic fibers. A wide variety of cellulosic fibers may generally be employed in the process of the present invention. Illustrative cellulosic fibers that may be employed in the practice of the invention include, but are not limited to, wood and wood products, such as wood pulp fibers (e.g., softwood or hardwood pulp fibers); non-woody paper-making fibers from cotton, from straws and grasses, such as rice and esparto, from canes and reeds, such as bagasse, from bamboos, from stalks with bast fibers, such as jute, flax, kenaf, cannabis, linen and ramie, and from leaf fibers, such as abaca and sisal. It is also possible to use mixtures of one or more cellulosic fibers. It is generally desired that the cellulosic fibers used herein be wettable. Suitable cellulosic fibers include those that are naturally wettable. However, naturally non-wettable fibers can also be used.

Softwood sources include trees sources, such as pines, spruces, and firs and the like. Hardwood sources, such as oaks, eucalyptuses, poplars, beeches, and aspens, may be used, but this list is by no means exhaustive of all the hardwood sources that may be employed in the practice of the invention. Hardwood fiber sources generally contain fibers of a shorter length than softwood sources. Many times, sloughing occurs when shorter fibers flake or fall from the outer hardwood layers of multi-layered tissues.

Fibers from different sources of wood exhibit different properties. Hardwood fibers, for example, tend to show high degrees of “fuzziness” or softness when placed on the exterior surface of a tissue product, such as a bathroom tissue.

The preparation of cellulosic fibers from most cellulosic sources results in a heterogeneous mixture of cellulosic fibers. The individual cellulosic fibers in the mixture exhibit a broad spectrum of values for a variety of properties such as length, coarseness, diameter, curl, color, chemical modification, cell wall thickness, fiber flexibility, and hemicellulose and/or lignin content. As such, seemingly similar mixtures of cellulosic fibers prepared from the same cellulosic source may exhibit different mixture properties, such as freeness, water retention, and fines content because of the difference in actual cellulosic fiber make-up of each mixture or slurry.

Materials containing natural fibers, such as cellulosic fibers, can also include coform webs and hydroentangled webs. In the coform process, at least one meltblown diehead is arranged near a chute through which other materials are added to a meltblown web while it is forming. Such other materials may be natural fibers, superabsorbent particles, natural polymers (for example, rayon) and/or synthetic polymers (for example, polypropylene or polyester) fibers, for example, where the fibers may be of staple length.

Any of the above mentioned natural fibers may be combined with the meltblown fibers, such as wool, cotton, flax, hemp and wood pulp. Wood pulps include standard softwood fluffing grade such as CR-1654 (US Alliance Pulp Mills, Coosa, Ala.). Pulp may be modified in order to enhance the inherent characteristics of the fibers and their processability. Curl may be imparted to the fibers by methods including chemical treatment or mechanical twisting. Curl is typically imparted before crosslinking or stiffening. Pulps may be stiffened by the use of crosslinking agents such as formaldehyde or its derivatives, glutaraldehyde, epichlorohydrin, methylolated compounds such as urea or urea derivatives, dialdehydes such as maleic anhydride, non-methylolated urea derivatives, citric acid or other polycarboxylic acids. Pulp may also be stiffened by the use of heat or caustic treatments such as mercerization. Examples of these types of fibers include NHB416, which is a chemically crosslinked southern softwood pulp fibers which enhances wet modulus, available from the Weyerhaeuser Corporation of Tacoma, WA. Other useful pulps are debonded pulp (NF405) and non-debonded pulp (NB416) also from Weyerhaeuser. HPZ3 from Buckeye Technologies, Inc. of Memphis, Tenn., has a chemical treatment that sets in a curl and twist, in addition to imparting added dry and wet stiffness and resilience to the fiber. Another suitable pulp is Buckeye HP2 pulp and still another is IP Supersoft from International Paper Corporation. Suitable rayon fibers are 1.5 denier Merge 18453 fibers from Acordis Cellulose Fibers Incorporated of Axis, Ala.

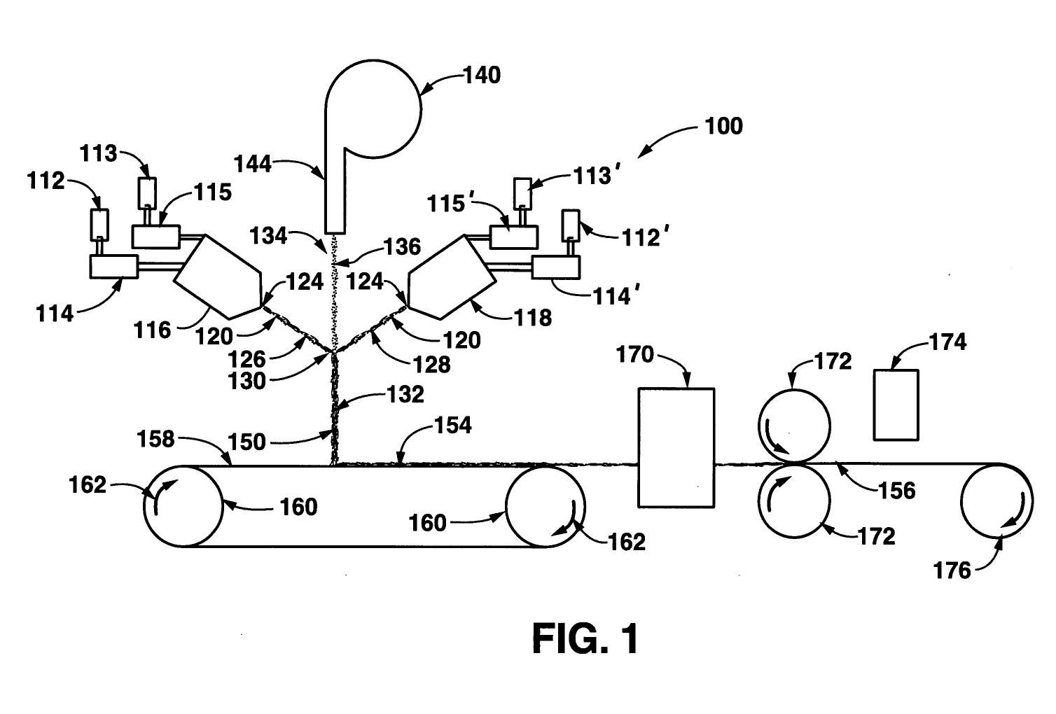

Any process for making a coform web can be utilized in accordance with the present disclosure. For example, in one embodiment, a coform web can be produced according to the process depicted in FIG. 1. FIG. 1 schematically shows a process and apparatus for forming the coform nonwoven web of the present invention using two meltblown dies which is generally represented by reference numeral 100. It should be noted that process of the present invention can be practiced using a single meltblown die. For ease of explanation, the process will be described in terms of using two meltblown dies. The process line 100 is arranged to produce bicomponent substantially continuous filaments, but it should be understood that the present invention comprehends nonwoven webs made with multicomponent filaments having more than two components. For example, the web of the present invention can be made with filaments having three, four or more components. In forming the nonwoven composite structure of the present invention, pellets or chips, etc. (not shown) of a thermoplastic polymer are introduced into a pellet hoppers 112, 112′, 113 and 113′ of an extruders 114, 114′, 115 and 115′.

The extruders 114, 114′, 115 and 115′ have an extrusion screw (not shown) which is driven by a conventional drive motor (also not shown). As the polymer advances through the extruders 114, 114′, 115 and 115′, due to rotation of the extrusion screw by the drive motor, it is progressively heated to a molten state. Heating the thermoplastic polymer to the molten state may be accomplished in a plurality of discrete steps with the temperature of the thermoplastic polymer being gradually elevated as it advances through discrete heating zones of the extruders 114, 114′, 115 and 115′ toward two meltblowing dies 116 and 118, respectively. The meltblowing dies 116 and 118 may be yet another heating zone where the temperature of the thermoplastic resin is maintained at an elevated level for extrusion.

Although not shown in FIG. 1, each meltblowing die is configured so that at least two streams of perturbed attenuating fluid per die converge to form a single stream of fluid which entrains and attenuates molten threads 120, as the threads 120 exit small holes or orifices 124 in each meltblowing die. The molten threads 120 are attenuated into filaments or, depending upon the degree of attenuation, microfibers, of a small diameter which is usually less than the diameter of the orifices 124. Thus, each meltblowing die 116 and 118 has a corresponding single stream of fluid 126 and 128, containing entrained and attenuated polymer filaments. The fluid streams 126 and 128 containing polymer filaments are aligned to converge at an impingement zone 130, and form a converged fluid stream 132.

One or more types of the second material 136, which can include fibers and/or particulates are added to the two streams 126 and 128 of multicomponent filaments or microfibers 120 at the impingement zone 130. Introduction of second fibers or particulates 136 into the two streams 126 and 128 of multicomponent filaments 120 is designed to produce a distribution of the second material 136 within the combined streams 126 and 128 of multicomponent filaments. This may be accomplished by merging a secondary gas stream 134 containing the second fibers or particles 136 between the two streams 126 and 128 of the multicomponent filaments 120 so that all three gas streams converge in a controlled manner at the impingement zone 130.

Apparatus 140 generates the second gas stream 134 containing the second fibers or particulate 136. The apparatus for accomplishing the merger of the fluid streams 126, 128 and 134 may include a conventional picker or particulate injection system. In a conventional picker roll arrangement, a plurality of teeth that are adapted to separate a mat or batt of an fibrous material into the individual fibers. The sheets or mats of the fibrous material are fed to the picker roll by a roller arrangement and the teeth of the picker roll separate the mat of fibrous material into separate fibers 136 which are conveyed toward the streams of thermoplastic multicomponent polymer filaments 126 and 128 through a nozzle 144, and optionally a chute 146. Generally a gas, for example, air, is supplied to the picker via a gas duct. The gas is supplied in sufficient quantity to serve as a medium for conveying the second fibers 136 through the nozzle 144. The gas may be supplied by any conventional arrangement such as, for example, an air blower (not shown). It is contemplated that additives and/or other materials may be add to or entrained in the gas stream to treat the second fibers.

The second material 136 generally maintains its velocity in both magnitude and direction. An example of a conventional picker can be found in, for example, U.S. Pat. No. 4,100,324 to Anderson, et al., hereby incorporated by reference in its entirety, which discusses the picker in more detail.

The width of the nozzle 144 should be aligned in a direction generally parallel to the width of the meltblowing dies 116 and 118. Desirably, the width of the nozzle 144 should be about the same as the width of the meltblowing dies 116 and 118. The width of the optional chute is likewise about the same as the width of the meltblowing dies 116 and 118. Usually, the width of the nozzle 144 should not exceed the width of the sheets or mats that are being fed to the picker roll. Generally speaking, it is desirable for the length of the nozzle 144 to be as short as equipment design will allow.

The apparatus 140 may also be a conventional particulate injection system to form a nonwoven web or coform composite structure 154 containing various particulates. In addition, a combination of both particulates and fibers could be added to the thermoplastic multicomponent polymer filaments prior to formation of the coform nonwoven web 154, if both a conventional particulate injection system and a conventional picker are used.

FIG. 1 further illustrates that the secondary fluid stream 134 carrying the second material 136 is directed between the fluid streams 126 and 128 of thermoplastic multicomponent polymer filaments so that the streams contact at the impingement zone 130. Apparatus 140 is shown to be located between the meltblown dies 116 and 118, however, it should be noted that the apparatus 140 could be located below the meltblown dies 116 and 118 such that the second material could be injected into the converged stream 132, at or below the impingement zone 130 of fluid streams 126 and 128. The velocity of the secondary fluid stream 134 is usually adjusted so that it is less than the velocity of each stream 126 and 128 of thermoplastic multicomponent polymer filament when the streams contact at the impingement zone 130, which results in better homogenous mixing of the second material with the multicomponent filaments. However, it should be noted that the velocity of the fluid stream 134 can be greater than the velocity of streams 126 or 128, or the converged stream 132.

The perturbed nature of the streams 126 and 128 and the velocity difference these streams 126, 128 and the fluid stream 134 of the second material 136, results in the second material 136 being integrated into the streams of the multicomponent thermoplastic polymer filaments 126 and 128 in such manner that the second material 136 becomes homogeneously integrated into the multicomponent thermoplastic polymer filaments 120. Generally, for increased production rates the perturbed fluid streams which entrain and attenuate the multicomponent thermoplastic polymer fibers 120 should have a comparatively high initial average velocity, for example, from about 200 feet to over 1,000 feet per second. However, the velocity of those fluid streams 126,128 decreases rapidly as they expand and become separated from the meltblowing die. Thus, the velocity of those fluid streams 126, 128 at the impingement zone may be controlled by adjusting the distance between the meltblowing die and the impingement zone 130. The fluid stream 134, which carries the second material 136, will have a low initial velocity when compared to the fluid streams 126 and 128 which carry the meltblown fibers. However, by adjusting the distance from the nozzle 144 to the impingement zone 130 (and the distances that the meltblown fiber gas streams 126 and 128 must travel), the velocity of the fluid stream 134 can be controlled to be greater than the meltblown fiber fluid streams 126 and 128 at the impingement zone.

Due to the fact that the multicomponent thermoplastic polymer fibers 120 are usually still semi-molten and tacky at the time of incorporation of the second material 136 into the multicomponent thermoplastic polymer filaments containing streams 126 and 128, the second material 136 is usually not only mechanically entangled within the matrix formed by the thermoplastic polymer fibers 120 but is also thermally bonded or joined to the multicomponent thermoplastic polymer fibers 120.

In order to convert the composite stream 150 of multicomponent thermoplastic polymer fibers 120 and the second material 136 into a composite nonwoven structure 154 composed of a coherent matrix of the multicomponent thermoplastic polymer fibers 120 having the second material 136 distributed therein, a collecting device is located in the path of the composite stream 150. The collecting device may be an endless belt 158 conventionally driven by rollers 160 and which is rotating as indicated by the arrow 162 in FIG. 1. Other collecting devices are well known to those of skill in the art and may be utilized in place of the endless belt 158. For example, a porous rotating drum arrangement could be utilized. The merged composite streams of multicomponent thermoplastic polymer filaments and the second material are collected as a coherent matrix on the surface of the endless belt 158 to form the composite nonwoven web 154. Vacuum boxes assist in retention of the matrix on the surface of the belt 158. The vacuum may be set at about 1 to about 4 inches of water column. Generally, in practicing the process of the present invention, as the line speed of the collecting device is increased, the frequency of the perturbation of the flow of fluid also needs to be increased.

The coform nonwoven web composite structure 154 is coherent and may be removed from the belt 158 as a self-supporting nonwoven material. Generally speaking, the composite structure has adequate strength and integrity to be used without any post-treatments such as pattern bonding, calendering and the like. However, the structure can be further stabilized by thermally bonding or compressing the composite structure. For example, a pair of pinch rollers or pattern bonding rollers, which may or may not be heated, may be used to bond portions of the material. Although such treatment may improve the integrity of the nonwoven composite structure 154, it also tends to compress and densify the structure.

If necessary or desired, the web 154 is then transported to a through air bonding (TAB) unit 170 to partially or fully activate the web 154. While the web 154 is partially or fully activated, it can be then densified, such as by compression through a nip formed by two calender rolls 172. Densification is desirable in a preferred embodiment to between about 0.01 g/cc and 0.50 g/cc, and more desirably to between about 0.05 g/cc and 0.20 g/cc for use in some personal product applications. The calendar rolls 172 may, but need not, provide point bonding of the web and may be heated to maintain the full activation of the web during densification. Alternatively, the calendar rolls 172 may be cooled to provide a means for removing heat from the fully activated web. The stabilized and densified web 156 can then be collected on a winding roll 176 or the like for later use, or in the alternative, the stabilized and densified web can be further processed directly from the formation process.

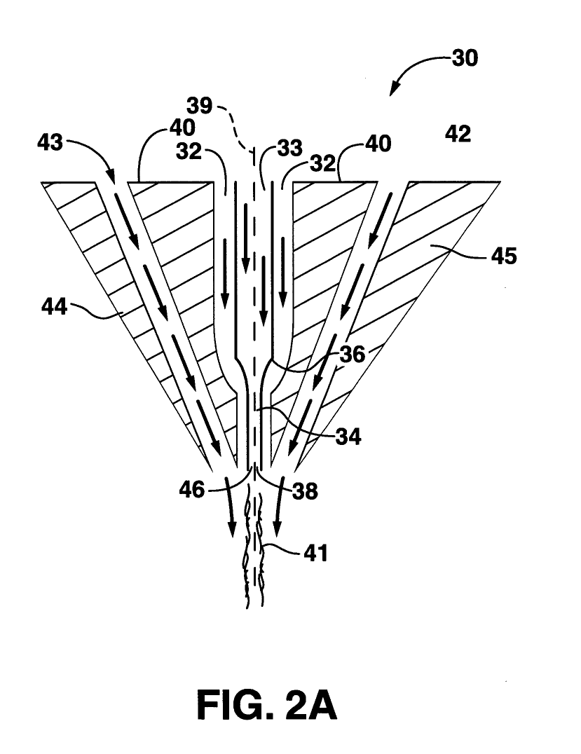

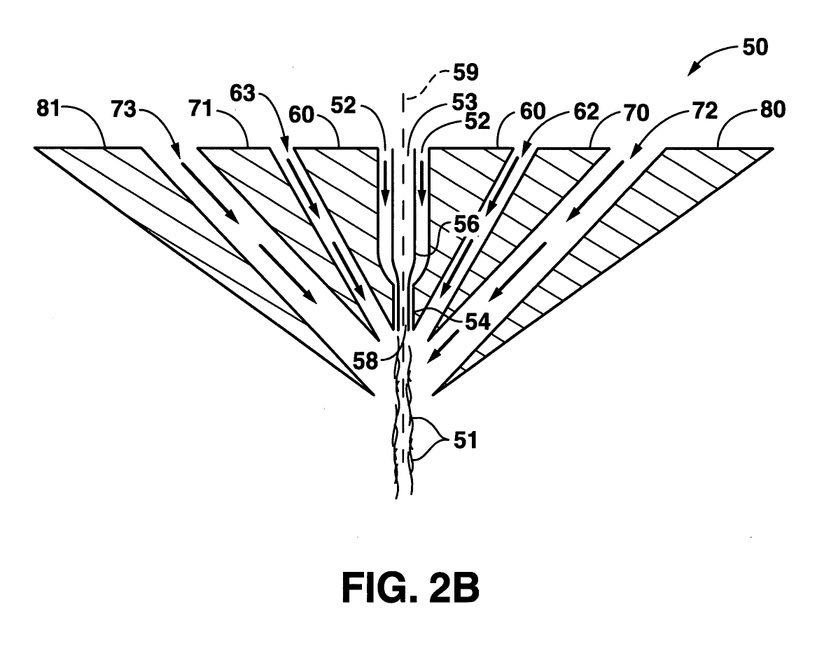

The meltblowing die of the present invention can have any configuration known to those skilled in the art. FIG. 2A shows a conventional meltblown die and FIG. 2B shows a meltblown die used with a cold air quench. These configurations for meltblown dies are well known in the art. For example U.S. Pat. No. 6,001,303 to Haynes et al, hereby incorporated by reference in its entirety, teaches a meltblown die with a cold air quench. In order to help explain the meltblown formation process herein for multicomponent filaments, the process will be briefly explained.

In FIG. 2A, a cross-section of a meltblown die 30 is shown. The polymeric components 32 and 33 are fed to a capillary 54. The polymeric components remain separated by a wall 36 until the liquefied polymeric components are at the end of the capillary, orifice 38. A die has a plurality of orifices 38. The polymeric filament components 31 and 32 are extruded through the orifices 38 in the direction of a primary axis designated by line 39. This axis bisects the die 30. A fluid stream 42 and 43 flows on each side of the orifice 38. The fluid streams 42 and 43 are perturbed as described above. The plates 44 and 45 direct the fluid stream 42 and 43 towards the orifice and the liquefied polymeric components. The fluid streams 42 and 43 attenuate and entrain the filaments formed.

In FIG. 2B, a cross-section of a cold air quench meltblown die 50 is shown. The polymeric components are has the polymeric components 52 and 53 are fed to a capillary 54. The polymeric components remain separated by a wall 56 until the liquefied polymeric components are at the end of the capillary, orifice 58. Again, the die head has a plurality of orifices 58. The polymeric components filaments 52 and 53 are extruded through the orifices 58 in the direction of a primary axis designated by line 59. This axis bisects the die 50. Fluid streams 62, 63, 72 and 73 flow on each side of the orifice 58. Fluid streams 72 and 73 are the “primary air” flows which contain cold air that attenuates and entrains the filaments with a flow in the direction of the primary axis. The fluid streams, sometimes referred to as the “secondary air”, 62 and 63 are heated only to a temperature that prevents the premature quenching of the filaments as the filaments leave the orifice 58. The plates 70 and 71 direct the fluid stream 62 and 63 towards the orifice and the liquefied polymeric components. Likewise, plates 80 and 81 direct the cold air streams 72 and 73 toward the orifice and the liquefied polymeric components. The fluid streams 72 and 73 attenuate and entrain the filaments formed. In using the cold air quench die, the primary fluid streams 72 and 73 are perturbed.

In using the cold air quench, typically the temperature of the cold air is less than the temperature of the secondary air. Generally, the cold air stream is desirably at least 300.degree. F. below the temperature of the secondary fluid streams, however, it is not absolutely required. For more detail regarding operation of the cold air quench meltblown die, attention is directed to U.S. Pat. No. 6,001,303, to Haynes, which is hereby incorporated by reference.

When containing cellulosic materials such as pulp fibers, a coform material may contain the cellulosic material in an amount from about 10% by weight to about 80% by weight, such as from about 30% by weight to about 70% by weight. For example, in one embodiment, a coform material may be produced containing pulp fibers in an amount from about 40% by weight to about 60% by weight. In general, coform webs can have a basis weight of from about 10 and about 250 gsm, specifically between about 15 and about 200 gsm, more specifically between about 25 and about 125 gsm, most specifically between about 30 and about 100 gsm. In some embodiments, a coform web can have a basis weight of between about 90 and 200 gsm.

Once a coform material is treated with a bacteriostatic composition in accordance with the present disclosure, in one embodiment, the bacteriostatic composition may bond to the cellulosic material contained within the coform material. Of particular advantage, the present inventors discovered that when coform materials are treated with a bacteriostatic composition, the hydrophobicity of the material is greatly increased. Due to the increased hydrophobicity, the barrier properties of the material are greatly improved. For instance, it has been discovered that the material is well suited to serving as a barrier to blood and other biological fluids. In fact, the barrier properties of the material are similar to conventional barrier materials, such as spunbond/meltblown/spunbond laminates. Once treated with the bacteriostatic composition, however, the coform material not only serves as a barrier but also binds and traps negatively charged matter, such as bacteria. As such, a treated coform web can continue to serve to trap negatively charged matter even in the event of barrier failure of the web.

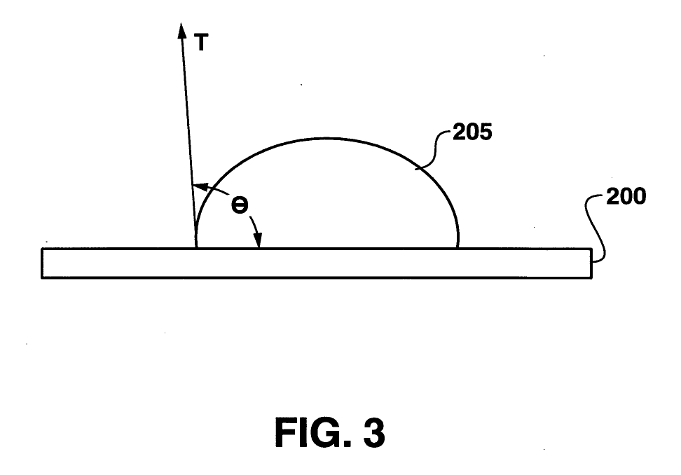

One way to test the hydrophobicity of a material and its ability to serve as a barrier layer is to test the material for its contact angle against various liquids. When a liquid does not completely spread on a substrate, a contact angle is formed. A contact angle is geometrically defined as the angle on the liquid side of the tangential line drawn through the 3-phase boundary where a liquid, gas and solid intersect. For example, referring to FIG. 3, liquid 205 on substrate 200 creates a tangent line T. The contact angle θ is the angle measured from the tangent line T to the surface of substrate 200 on the liquid side of the tangent line T.

The contact angle is a quantitative measure of the wetting of a solid by a liquid. It is a direct measure of interactions taking place between the gas/liquid/solid interface. A higher contact angle generally indicates greater resistance to the liquid and greater hydrophobicity.

Treating the nonwoven materials, such as coform materials, in accordance with the present disclosure has been found to increase in contact angle of a liquid on the material by at least 10% when compared to untreated substrates, such as increased by at least 20%, and even by at least 30%. For instance, when tested against water, the contact angle of nonwoven materials made in accordance with the present disclosure may be greater than about 110°, such as greater than about 115°, such as greater than about 120°. When tested against blood, the contact angle of the nonwoven material may be greater than about 115°, such as greater than about 118°, such as greater than about 120°.

The amount of bacteriostatic composition applied to the substrate may vary and depends on numerous factors. The amount applied, for instance, depends upon the ingredients contained in the bacteriostatic composition, the material used to form the substrate, and the amount of bonding that can occur between the composition and the substrate. Other factors include the desired amount of activity needed on the wound or surgical dressing and the type of wound or incision site that may be treated.

In general, when applied to a substrate, the bacteriostatic composition may be applied in a treated area in an amount from about 0.01% to about 20% by weight, such as from about 0.05% to about 10% by weight. In still other embodiments, the bacteriostatic composition may be applied to the substrate in a treated area in an amount from about 5% to about 8% by weight.

As described above, the bacteriostatic composition traps and binds negatively charged materials, thus removing them from their environment. Additionally, it is believed that the bacteriostatic composition can also reduce bacterial growth according to a bacteria binding procedure. For instance, when applied to a substrate, the bacteriostatic composition may reduce bacterial growth according to a bacteria binding procedure by at least about 50%, such as at least about 75%. In other embodiments, for instance, the treated substrate may reduce bacterial growth by at least about 80%, such as by at least about 90%.

The webs of the present invention can be used in any manner. In one embodiment, the webs can have medical uses because of their ability to help preventing the spread of or infection with pathogens. Coform materials as described above are well suited for being used as wound or surgical dressings in accordance with the present disclosure. It should be understood, however, that due to the enhanced hydrophobicity, the coform materials may be used in other applications. For instance, such coform materials may be used to construct surgical gowns, surgical drapes, surgical masks, and other similar garments. However, it is to be understood that the webs of the present invention are not limited by the use of the web.

The present invention may be better understood with reference to the following examples.

### EXAMPLE 1

As described above, coform materials treated with a bacteriostatic composition in accordance with the present disclosure display significantly enhanced hydrophobicity. Due to the increased hydrophobicity, coform materials are particularly well suited to being used in any applications where a barrier layer is needed and as a wound or surgical dressing. The following example was conducted in order to demonstrate the improved hydrophobicity.

A coform web containing 60% pulp (softwood) fibers and 40% meltblown fibers was treated with a 1% by weight aluminum chlorohydrate solution. The solution was applied to the material using a dip and nip procedure with a 5 lb. nip. The sample was then dried at 80° C. for 20 minutes. The sample was then rinsed with distilled water using the same dip and nip procedure. Again, the sample was dried at 80° C. for 20 minutes to form a treated substrate.

Ten microliter droplets of O-positive blood (treated with an anticoagulant), surfactant solution (0.5 weight % TWEEN 20 in water, dyed blue using FD&C Blue #1), protein solution (1 mg/mL b-casein, dyed green with FD&C Green #3) and tap water were placed on the sample and allowed to sit for 15 minutes. The same procedure was also carried out on a standard spunbond/meltblown/spunbond laminate that had a basis weight of 33.9 gsm (1 osy) and on an untreated sample of the coform material.

After 15 minutes, the blood and surfactant solution had wetted out the SMS laminate and had seeped through the material. The untreated coform material absorbed the blood, the surfactant solution, and the protein. All three solutions soaked through the material.

With respect to the treated coform material, on the other hand, the blood did not seep through the material. The surfactant wetted the material but did not seep all the way through the material. Further, the dye combined with the surfactant was held in place. The protein solution also began to seep into the treated coform material but was captured within the material and did not soak through the material.

Contact angle measurements were also obtained from all three materials. Specifically, the treated coform material made according to the present disclosure and the SMS laminate were tested against water, the protein solution, and the blood. The untreated coform material, on the other hand, was tested against blood alone.

Contact angle measurements were obtained by adhering the samples to a glass slide with double-sided adhesive tape. Ten microliter of the solutions were applied to the substrate held in place by the tape and the contact angle was measured. The following results were obtained:

TABLE 1
Spunbond/Meltblown/Spunbond (SMS) Laminate

| Contact Angle (°) | | | | | | Avg. |
|---|---|---|---|---|---|---|
| Water | 87.5 | 101 | 95 | 108.2 | 120 | 102 |
| β-caesin | 112 | 108.5 | 105 | 118 | 120 | 113 |
| protein | | | | | | |
| O-positive | 103.2 | 115 | 122 | 122.5 | 107 | 114 |
| blood | | | | | | |

TABLE 2
Untreated Coform Material

| | |
|---|---|
| Contact Angel (°) | Avg. |

| | | | | | | |
|---|---|---|---|---|---|---|
| O-positive | 101.5 | 112.5 | 83 | 66.5 | 79 | 89 |
| blood | | | | | | |

TABLE 3
Treated Coform Material

| Contact Angle (°) | | | | | | Avg. |
|---|---|---|---|---|---|---|
| Water | 129 | 120 | 123 | 121 | 118.7 | 122 |
| β-caesin | 116 | 113 | 111 | 102 | 122 | 113 |
| protein | | | | | | |
| O-positive | 120 | 122 | 121 | 133 | 114 | 122 |
| blood | | | | | | |

As shown above, treating the coform material with the bacteriostatic composition significantly increases the contact angle of the material. For instance, with respect to blood, the contact angle was increased by greater than 30% in comparison to the untreated sample.

The treated coform material also had greater contact angles than the SMS laminate tested when tested against water and blood.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A substrate capable of trapping negatively charged materials, the substrate comprising:
a nonwoven web comprising fibers; and
a composition contained in said nonwoven web, said composition comprising a chemical compound having a net positive charge, said chemical compound comprising a cationic polymer, a cationic oligomer, a nanoparticle, or mixtures thereof, said composition being contained in said nonwoven web such that said nonwoven web has a contact angle of at least about 110° with water.

2. A substrate as in claim 1, wherein said composition is contained in said nonwoven web such that said nonwoven web has a contact angle of at least about 115° with blood

3. A substrate as in claim 1, wherein said composition is contained in said nonwoven web such that said nonwoven web has a contact angle of at least about 120° with water.

4. A substrate as in claim 1, wherein said composition is contained in said nonwoven web such that said nonwoven web has a contact angle with blood of at least about 120°.

5. A substrate as in claim 1, wherein said chemical compound comprises a metal ion.

6. A substrate as in claim 1, wherein said chemical compound comprises an aluminum oligomer or an aluminum salt.

7. A substrate as in claim 1, wherein said fibers comprise natural fibers.

8. A substrate as in claim 7, wherein said natural fibers are selected from the group consisting of wool, cotton, flax, hemp, and wood pulp.

9. A substrate as in claim 7, wherein said natural fibers are cellulosic fibers.

10. A substrate as defined in claim 1, wherein said nonwoven web comprises natural fibers and synthetic fibers.

11. A substrate as in claim 10, wherein said nonwoven web comprises a coform web.

12. A substrate as in claim 11, wherein said coform web comprises cellulosic fibers and meltblown fibers.

13. A nonwoven web having increased hydrophobicity comprising:
a coform web containing polymer fibers and cellulosic fibers, said cellulosic fibers being present in an amount of at least about 30% by weight; and
a bacteriostatic composition contained in said coform web, said bacteriostatic composition comprising a chemical compound having a net positive charge, said chemical compound comprising a cationic polymer, a cationic oligomer, a particle, or mixtures thereof, said bacteriostatic composition being contained in said coform web such that said coform web has a contact angle of at least about 110° with water.

14. A nonwoven web as in claim 13, wherein said bacteriostatic composition being contained in said coform web such that said coform web has a contact angle of at least about 115° with blood

15. A nonwoven web as in claim 13, wherein the chemical compound comprises an aluminum oligomer or an aluminum salt.

16. A nonwoven web as in claim 13, wherein the aluminum oligomer comprises aluminum chlorohydrate or aluminum chlorohydrol.

17. A nonwoven web as in claim 13, wherein the coform web has a contact angle with water of at least about 120° and has a contact angle with blood of at least 120°.

18. A nonwoven web as defined in claim 13, wherein the cellulosic fibers contained within the coform web comprise pulp fibers, the pulp fibers being present in an amount of at least about 30% by weight.

19. A nonwoven web as defined in claim 13, wherein the cellulosic fibers contained within the coform web comprise pulp fibers, the pulp fibers being present in an amount of at least about 50% by weight.

20. A nonwoven web as defined in claim 13, wherein the coform web has a basis weight of from about 30 gsm to about 100 gsm.

21. A wound or surgical dressing, a surgical drape, a surgical mask, a surgical glove, or a surgical gown containing the nonwoven web as defined in claim 13.

22. A method of producing a coform web having increased hydrophobicity comprising:
producing a coform web containing polymer fibers and cellulosic fibers, said cellulosic fibers being present in an amount of at least about 30% by weight; and
incorporating a bacteriostatic composition into said coform web, said bacteriostatic composition comprising a chemical compound having a net positive charge, said chemical compound comprising a cationic polymer, a cationic oligomer, a particle, or mixtures thereof, said bacteriostatic composition being contained in said coform web such that said coform web has a contact angle of at least about 110° with water.
